(19) United States
(12) Patent Application Publication
(10) Pub. No.: US 2018/0230956 A1
(43) Pub. Date: Aug. 16, 2018

(54) METHOD AND APPARATUS WITH ARRANGEMENT OF FUEL EJECTION ORIFICES CONFIGURED FOR MITIGATING COMBUSTION DYNAMICS IN A COMBUSTION TURBINE ENGINE

(71) Applicant: Siemens Aktiengesellschaft, München (DE)

(72) Inventors: Juan Enrique Portillo Bilbao, Oviedo, FL (US); Rajesh Rajaram, Winter Park, FL (US); Bernd Prade, Mülheim (DE); Jared M. Pent, Gotha, FL (US)

(21) Appl. No.: 15/751,580

(22) PCT Filed: Aug. 24, 2015
(86) PCT No.: PCT/US2015/046498

§ 371 Date: Feb. 9, 2018

(51) Int. Cl. F02M 61/18; F23R 3/28

(52) U.S. Cl. CPC F02M 61/1806; F23R 2900/00014; F23R 3/286

(57) ABSTRACT

Apparatus and method for a combustion turbine engine are provided. A pre-mixing passage (24) has an upstream inlet arranged to receive a flow of air to be mixed with fuel. A fuel-injecting lance (12) is disposed in the pre-mixing passage. At least a first fuel ejection orifice (40) is disposed at a first axial location of the fuel-injecting lance. At least a second ejection orifice (42) is disposed at a second axial location of the fuel-injecting lance. A spacing between the first and second axial locations is arranged to effect oscillatory interference patterns in pockets comprising mixtures of air and fuel that flow towards a downstream outlet of the pre-mixing passage. The oscillatory interference patterns may be effective to promote homogeneity in the mixtures of air and fuel and dampen thermoacoustic oscillations in a flame (46) formed upon ignition of the mixtures of air and fuel.

### BACKGROUND

### 1. Field

Disclosed embodiments are generally related to method and apparatus for a combustion turbine engine, such as gas turbine engine, and, more particularly, to method and apparatus with an arrangement of fuel ejection orifices configured for mitigating combustion dynamics that may develop in jet flames.

### 2. Description of the Related Art

Certain gas turbine engines may use combustors that form a plurality of jet flames involving relatively long pre-mixing conduits towards achieving appropriate premixing of air and fuel, and meeting emissions targets. These flames can develop self-induced thermo-acoustic oscillations that may constitute an undesirable side-effect of the combustion process. For example, such thermo-acoustic oscillations may pose undue mechanical and thermal stress on combustor components.

### BRIEF DESCRIPTION OF THE DRAWINGS

FIG. 1 is an isometric view of one non-limiting example of a combustor apparatus embodying aspects of the present invention, as may be used in a combustion turbine engine.

FIG. 2 is a side view schematic of one non-limiting embodiment of a fuel-injecting lance including fuel ejection orifices arranged to form oscillatory interference patterns (e.g., destructive waveform interference) effective to dampen thermoacoustic oscillations in a resulting flame.

FIGS. 3 and 5 are respective schematics that may be helpful for conceptualizing further non-limiting arrangements of fuel ejection orifices that may be used to implement aspects of the present invention.

FIG. 4 is a conceptual representation of a pocket comprising mixtures of air and fuel that may result from the fuel ejection orifice arrangement of FIG. 3, and FIG. 6 is a conceptual representation of a pocket comprising mixtures of air and fuel resulting from the fuel ejection orifice arrangement of FIG. 5

FIG. 7 is a schematic of yet a further non-limiting arrangement of fuel ejection orifices that may be used to implement aspects of the present invention.

FIGS. 8 and 9 illustrate respective plots of waveforms helpful for comparing a non-limiting example of experimental data (FIG. 9) obtained in a disclosed fuel injector embodying an arrangement of fuel ejection orifices configured for mitigating combustion dynamics that may develop in jet flames relative to equivalent experimental data (FIG. 8) obtained in a fuel injector without such an arrangement.

### DETAILED DESCRIPTION

The inventors of the present invention have recognized certain issues that can arise in the context of certain prior art combustors that may be used in combustion turbine engines, such as gas turbine engines. For example, combustors that form a plurality of jet flames that may involve relatively long pre-mixing ducts that can affect combustion dynamics due to their length relative to acoustic wavelengths of the combustor system. One non-limiting example of such combustors may be a jet flame combustor, which can develop self-induced thermoacoustic oscillations in the jet flames, as may be caused by respective fluctuations in the mass flow of fuel and air that in turn may cause pockets of fuel/air mixtures with distinctive differences in equivalence ratio (e.g., rich/lean pockets). These flame oscillations can detrimentally affect combustion dynamics in the jet flames and can further limit the ability to tune the combustor system towards achieving lower levels of NOx emissions.

In view of such recognition, the present inventors propose an improved fuel injector comprising an array of fuel-ejection locations strategically arranged to form oscillatory interference patterns (e.g., destructive wave interference) effective to reduce the magnitude of the differences of equivalence ratio in the pockets of fuel/air mixtures that may be formed in the pre-mixing ducts and thus resulting in more homogenous air/fuel mixture exiting the ducts and thus relatively more steadier flames. That is, flames with a reduced level of self-induced oscillations. The proposed fuel injector is believed to be effective to spread the convective time of equivalence ratio perturbations that otherwise would develop in the pockets of fuel/air mixtures in the pre-mixing ducts, and thus the proposed fuel injector effectively detunes the combustor from the system acoustics, which in turn is conducive to a wider operating envelope that provides the ability to tune the combustor system towards achieving lower levels of NOx emissions.

In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

The terms “comprising”, “including”, “having”, and the like, as used in the present application, are intended to be synonymous unless otherwise indicated. Lastly, as used herein, the phrases “configured to” or “arranged to” embrace the concept that the feature preceding the phrases “configured to” or “arranged to” is intentionally and specifically designed or made to act or function in a specific way and should not be construed to mean that the feature just has a capability or suitability to act or function in the specified way, unless so indicated.

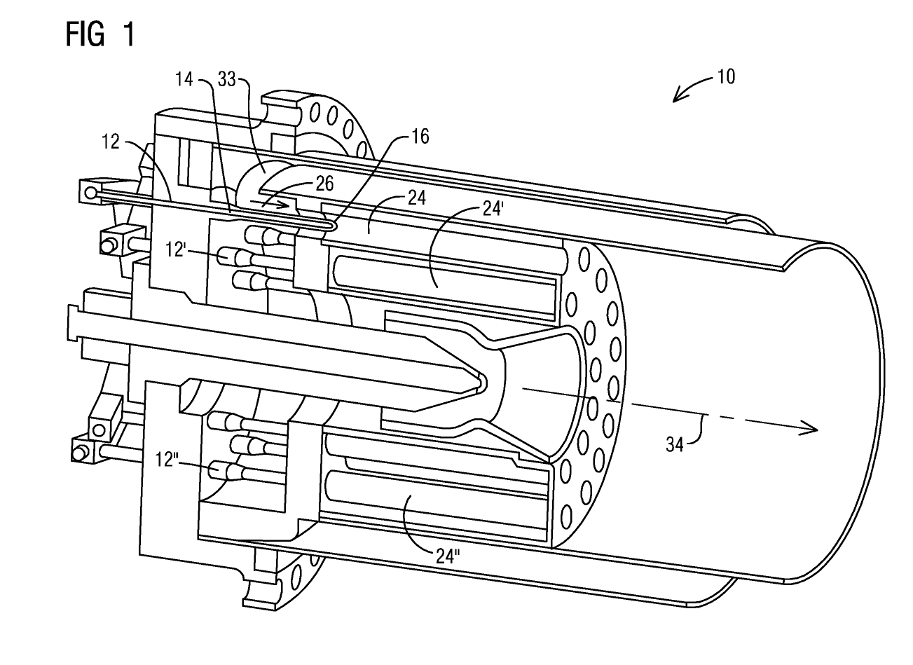

FIG. 1 is an isometric view of a combustor apparatus 10 embodying aspects of the present invention, as may be used in a combustion turbine engine, such as a gas turbine engine. In one non-limiting embodiment, apparatus 10 includes a fuel-injecting lance 12 disposed in a pre-mixing passage 24 (e.g., a pre-mixing tube). Fuel-injecting lance 12 includes a fuel circuit 14 to convey a fuel (e.g., natural gas or other suitable fuel) towards a downstream end 16 of lance 12. As may be appreciated in FIG. 1, pre-mixing passage 24 includes an upstream inlet arranged to receive the flow of air (schematically represented by arrow 26) to be mixed with the fuel. It will be appreciated that in a practical embodiment, a number of pre-mixing tubes, e.g., 24, 24′, 24″ and corresponding fuel-injecting lances, e.g., 12, 12′ 12″ may be circumferentially arranged in one or more annuli disposed about a longitudinal axis 34 of combustor apparatus 10. In one non-limiting embodiment, an annular flow-turning conduit 33 may be arranged to direct the flow of air into pre-mixing passages 24, 24′, 24″.

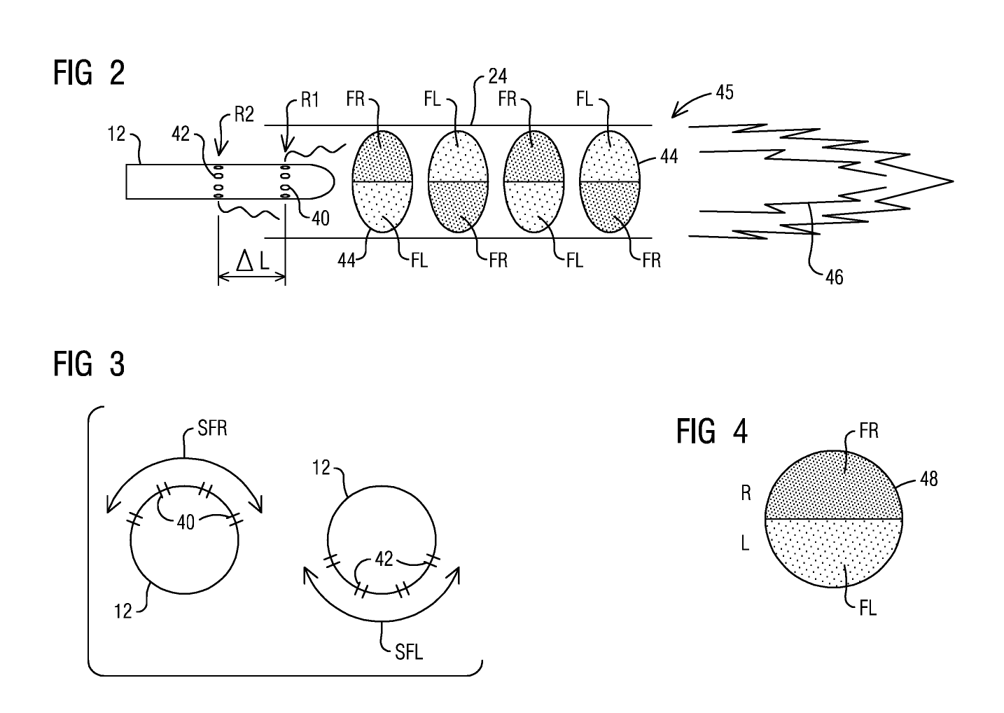

As may be appreciated in FIG. 2, at least a first fuel ejection orifice 40 is disposed at a first axial location of fuel-injecting lance 12. In a practical embodiment, fuel ejection orifice 40 may be part of a group of fuel ejection orifices disposed in a row (e.g., R1) at the first axial location. As may be further appreciated in FIG. 2, at least a second ejection orifice 42 is disposed at a second axial location of the fuel-injecting lance. In a practical embodiment, fuel ejection orifice 42 may be part of a group of fuel ejection orifices disposed in a row (e.g., R2) at the second axial location.

In one non-limiting embodiment, a spacing (e.g., labelled ΔL) between the first and second axial locations is arranged to effect oscillatory interference patterns (e.g., destructive wave interference) in pockets 44 comprising mixtures of air and fuel that flow towards a downstream outlet 45 of pre-mixing passage 24. As will be appreciated by those skilled in the art, destructive wave interference occurs when the phase shift between superimposed waves is an odd multiple of π. In one non-limiting embodiment, the spacing between rows R1 and R2 of fuel ejection orifices may be selected to introduce a phase shift Δφ, where Δφ=π*n, where n=1, 3, 5, 7, and so on and so forth. As will be appreciated by those skilled in the art, this phase shift (in the time domain) is a function of the local velocity profile and the distance between the premix passage and the flame. The phase shift introduced due to the spacing between rows R1 and R2 of fuel ejection orifices may be tuned to a given frequency of interest. It will be appreciated that aspects of the present invention are neither limited to two rows of fuel ejection orifices nor to phase shifts based on an odd multiple of π since these parameters may be tailored based on the needs of a given application.

The oscillatory interference patterns are effective to promote homogeneity in the mixtures of air and fuel and dampen thermoacoustic oscillations in a flame 46 formed upon ignition of the mixtures of air and fuel. For example, in lieu of such pockets being made up of either fuel-rich or fuel-lean pockets, as would occur in certain prior art combustors, because of the destructive interference resulting from the relative axial positioning of rows R1 and R2 of the fuel ejection orifices, such pockets may now be advantageously characterized as effectively comprising both a fuel-rich (FR) zone and a fuel-lean (FL) zone, as conceptually indicated FIG. 2.

In one non-limiting embodiment, the respective rows of fuel ejection orifices R1, R2 may comprise circumferentially-extending rows of fuel ejection orifices respectively spanning at least respective portions of a perimeter of the fuel-injecting lance. In one non-limiting embodiment, the circumferentially-extending row of fuel ejection orifices at the first axial location may comprise fuel ejection orifices configured for fuel-rich injection, and the circumferentially-extending row of fuel ejection orifices at the second axial location may comprises fuel ejection orifices configured for fuel-lean injection. Alternatively, the circumferentially-extending row of fuel ejection orifices at the first axial location may comprise fuel ejection orifices configured for fuel-lean injection, and the circumferentially-extending row of fuel ejection orifices at the second axial location may comprise fuel ejection orifices configured for fuel-rich injection.

For example, in one non-limiting embodiment, as schematically represented in FIG. 3, fuel ejection orifices 40 at the first axial location may be configured for fuel-rich injection and may be disposed over a first segment (e.g., segment labelled SFR) of the perimeter of the fuel-injecting lance, and fuel ejection orifices 42 at the second axial location may be configured for fuel-lean injection and may be disposed over a second segment (e.g., segment labelled SFL) of the perimeter of the fuel-injecting lance. In this non-limiting embodiment, first segment SFR and second segment SFL comprise circumferentially non-overlapping segments. FIG. 4 is a conceptual representation of a pocket 48 comprising mixtures of air and fuel that may result from the fuel ejection orifice arrangement of FIG. 3. In this example, pocket 48 is made up of a fuel-rich (FR) zone in correspondence with segment SFR and a fuel-lean (FL) zone in correspondence with segment SFL.

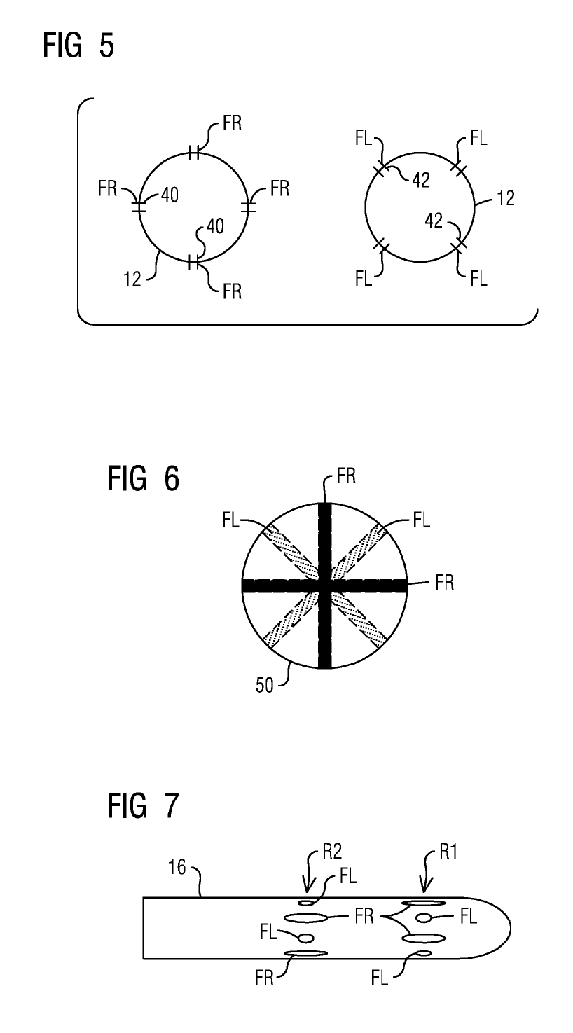

In another non-limiting embodiment, as schematically represented in FIG. 5, fuel ejection orifices 40 at the first axial location may be disposed over the perimeter of the fuel-injecting lance at a first set of circumferential locations (e.g., labelled FR to indicate fuel-rich injection), and the fuel ejection orifices 42 at the second axial location are disposed over the perimeter of the fuel-injecting lance at a second set of circumferential locations (e.g., labelled FL to indicate fuel-lean injection). In this non-limiting embodiment, the first set of circumferential locations FR are interspersed with the second set of circumferential locations FL to promote air/fuel mixing within the respective pockets, as conceptually illustrated in FIG. 6 where a pocket 50 comprises angularly interspersed components of fuel-lean (FL) and fuel-rich injection (FR).

As schematically illustrated in FIG. 7, it will be appreciated that the circumferentially-extending row of fuel ejection orifices at the first axial location, e.g., row R1 may include at least some fuel ejection orifices configured for fuel-rich injection (FR) and at least some fuel ejection orifices configured for fuel-lean injection (FL). Similarly, the circumferentially-extending row of fuel ejection orifices at the second axial location, e.g., row R2 may include at least some fuel ejection orifices configured for fuel-rich injection (FR) and at least some fuel ejection orifices configured for fuel-lean injection (FL).

It will be appreciated that aspects of the present invention are not limited to any particular pattern for the fuel ejection orifices in a given fuel injector since such patterns may be customized at the fuel injector level. Additionally, it will be appreciated that the designer has the flexibility to customize at the burner and/or the combustor system level the patterns for the fuel ejection orifices. For example, let us say that a given burner utilizes ten fuel injectors, then the respective patterns for the fuel ejection orifices in the ten fuel injectors need not be identical to one another since such patterns may be customized at the burner level. In yet another example, let us say that a given burner system in a gas turbine utilizes an arrangement of seven burners, then the patterns for the fuel ejection orifices in the seven burners in that burner arrangement need not be identical to one another since such patterns may be customized at the burner system level. It will be further appreciated that aspects of the present invention are not limited to any particular shape for the fuel ejection orifices. Non-limiting examples may be a circular shape, an elongated shape, an oval shape, a combination of two or more of the foregoing shapes.

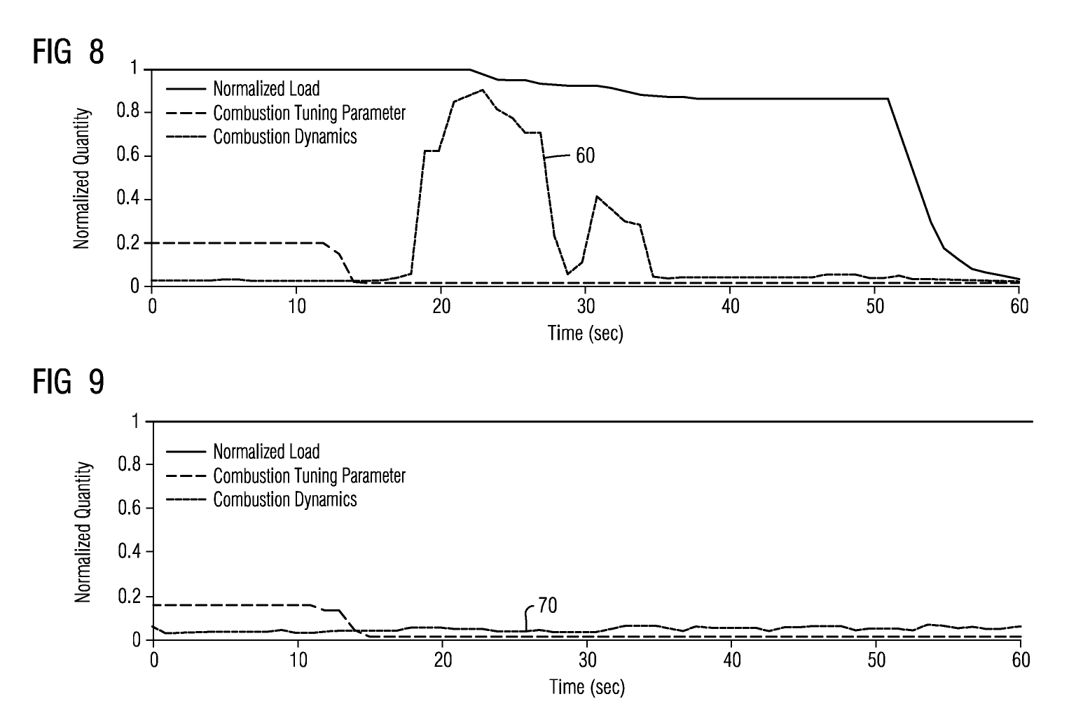

FIGS. 8 and 9 illustrate respective plots helpful for comparing a non-limiting example of experimental data (FIG. 9) obtained in a disclosed fuel injector embodying an arrangement of fuel ejection orifices configured for mitigating combustion dynamics relative to equivalent data (FIG. 8) obtained in a fuel injector without such an arrangement. More specifically note the substantial bands of combustion dynamics 60 in FIG. 8 compared to the practically negligible level of combustion dynamics 70 in FIG. 9.

In operation, disclosed embodiments are believed to provide a cost effective and reliable combustor apparatus with superior air-fuel mixing capability conducive to flames with a reduced level of self-induced oscillations. Additionally, disclosed embodiments are believed to provide an elegant means for detuning the combustor from system acoustics, which in turn is conducive to a wider operating envelope that provides the ability to tune the combustor system towards achieving lower levels of NOx emissions.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1-21. (canceled)

22. Apparatus for a combustion turbine engine, comprising:
a pre-mixing passage having an upstream inlet arranged to receive a flow of air to be mixed with fuel;
a fuel-injecting lance disposed in the pre-mixing passage;
at least a first fuel ejection orifice disposed at a first axial location of the fuel-injecting lance;
at least a second ejection orifice disposed at a second axial location of the fuel-injecting lance, wherein a spacing between the first and second axial locations is arranged to effect oscillatory interference patterns in pockets comprising mixtures of air and fuel that flow towards a downstream outlet of the pre-mixing passage,
wherein the at least first fuel ejection orifice is part of a plurality of fuel ejection orifices disposed in a row at the first axial location and the at least second fuel ejection orifice is part of a plurality of fuel ejection orifices disposed in a row at the second axial location,
wherein the respective rows of fuel ejection orifices comprise circumferentially-extending rows of fuel ejection orifices respectively spanning at least respective portions of a perimeter of the fuel-injecting lance,
wherein the circumferentially-extending row of fuel ejection orifices at the first axial location comprises fuel ejection orifices configured for fuel-rich injection, and the circumferentially-extending row of fuel ejection orifices at the second axial location comprises fuel ejection orifices configured for fuel-lean injection.

23. The apparatus of claim 22, wherein the fuel ejection orifices at the first axial location are disposed over a first segment of the perimeter of the fuel-injecting lance, and the fuel ejection orifices at the second axial location are disposed over a second segment of the perimeter of the fuel-injecting lance, wherein the first segment and the second segment comprise circumferentially non-overlapping segments.

24. The apparatus of 22, wherein fuel ejection orifices at the first axial location are disposed over the perimeter of the fuel-injecting lance at a first set of circumferential locations, and the fuel ejection orifices at the second axial location are disposed over the perimeter of the fuel-injecting lance at a second set of circumferential locations, wherein the first set of circumferential locations are interspersed with the second set of circumferential locations to promote air/fuel mixing within the respective pockets.

25. Apparatus for a combustion turbine engine, comprising:
a pre-mixing passage having an upstream inlet arranged to receive a flow of air to be mixed with fuel;
a fuel-injecting lance disposed in the pre-mixing passage;
at least a first fuel ejection orifice disposed at a first axial location of the fuel-injecting lance;
at least a second ejection orifice disposed at a second axial location of the fuel-injecting lance, wherein a spacing between the first and second axial locations is arranged to effect oscillatory interference patterns in pockets comprising mixtures of air and fuel that flow towards a downstream outlet of the pre-mixing passage,
wherein the at least first fuel ejection orifice is part of a plurality of fuel ejection orifices disposed in a row at the first axial location and the at least second fuel ejection orifice is part of a plurality of fuel ejection orifices disposed in a row at the second axial location,
wherein the respective rows of fuel ejection orifices comprise circumferentially-extending rows of fuel ejection orifices respectively spanning at least respective portions of a perimeter of the fuel-injecting lance, and
wherein 1) the circumferentially-extending row of fuel ejection orifices at the first axial location comprises fuel ejection orifices configured for fuel-rich injection, and the circumferentially-extending row of fuel ejection orifices at the second axial location comprises fuel ejection orifices configured for fuel-lean injection; or, wherein 2) the circumferentially-extending row of fuel ejection orifices at the first axial location comprises fuel ejection orifices configured for fuel-lean injection, and the circumferentially-extending row of fuel ejection orifices at the second axial location comprises fuel ejection orifices configured for fuel-rich injection.

26. The apparatus of claim 25, wherein the fuel ejection orifices at the first axial location are disposed over a first segment of the perimeter of the fuel-injecting lance, and the fuel ejection orifices at the second axial location are disposed over a second segment of the perimeter of the fuel-injecting lance, wherein the first segment and the second segment comprise circumferentially non-overlapping segments.

27. The apparatus of claim 25, wherein the fuel ejection orifices at the first axial location are disposed over the perimeter of the fuel-injecting lance at a first set of circumferential locations, and the fuel ejection orifices at the second axial location are disposed over the perimeter of the fuel-injecting lance at a second set of circumferential locations, wherein the first set of circumferential locations are interspersed with the second set of circumferential locations to promote air/fuel mixing within the respective pockets.

28. The apparatus of claim 25, wherein 1) the circumferentially-extending row of fuel ejection orifices at the first axial location in addition to the fuel ejection orifices configured for fuel-rich injection further comprises at least some fuel ejection orifices configured for fuel-lean injection, and the circumferentially-extending row of fuel ejection orifices at the second axial location in addition to the fuel ejection orifices configured for fuel-lean injection further comprises at least some fuel ejection orifices configured for fuel-rich injection; or wherein 2) the circumferentially-extending row of fuel ejection orifices at the first axial location in addition to the fuel ejection orifices configured for fuel-lean injection further comprises at least some fuel ejection orifices configured for fuel-rich injection, and the circumferentially-extending row of fuel ejection orifices at the second axial location in addition to the fuel ejection orifices configured for fuel-rich injection further comprises at least some fuel ejection orifices configured for fuel-lean injection.

29. Apparatus for a combustion turbine engine, comprising:
a pre-mixing passage having an upstream inlet arranged to receive a flow of air to be mixed with fuel;
a fuel-injecting lance disposed in the pre-mixing passage;
an array of ejection orifices comprising a first group of ejection orifices axially arranged in the fuel-injecting lance relative to a second group of ejection orifices to effect oscillatory interference patterns in pockets comprising mixtures of air and fuel that flow towards a downstream outlet of the pre-mixing passage,
wherein the first group of ejection orifices comprises at least a first fuel ejection orifice disposed at a first axial location of the lance, and the second group of ejection orifices comprises at least a second ejection orifice disposed at a second axial location of the lance, wherein a spacing between the first and second axial locations is arranged to effect the oscillatory interference patterns,
wherein the at least first fuel ejection orifice is part of a plurality of fuel ejection orifices disposed in a row at the first axial location and the at least second fuel ejection orifice is part of a plurality of fuel ejection orifices disposed in a row at the second axial location,
wherein the respective rows of fuel ejection orifices comprise circumferentially-extending rows respectively spanning at least respective portions of a perimeter of the fuel-injecting lance,
wherein the circumferentially-extending row of fuel ejection orifices at the first axial location comprises fuel ejection orifices configured for fuel-lean injection, and the circumferentially-extending row of fuel ejection orifices at the second axial location comprises fuel ejection orifices configured for fuel-rich injection.

30. The apparatus of claim 29, wherein fuel ejection orifices at the first axial location are disposed over a first segment of the perimeter of the fuel-injecting lance, and the fuel ejection orifices at the second axial location are disposed over a second segment of the perimeter of the fuel-injecting lance, wherein the first segment and the second segment comprise circumferentially non-overlapping segments.

31. The apparatus of claim 29, wherein fuel ejection orifices at the first axial location are disposed over the perimeter of the fuel-injecting lance at a first set of circumferential locations, and the fuel ejection orifices at the second axial location are disposed over the perimeter of the fuel-injecting lance at a second set of circumferential locations, wherein the first set of circumferential locations are interspersed with the second set of circumferential locations to promote air/fuel mixing within the respective pockets.

32. The apparatus of claim 29, wherein the circumferentially-extending row of fuel ejection orifices at the first axial location comprises at least some fuel ejection orifices configured for fuel-rich injection, and the circumferentially-extending row of fuel ejection orifices at the second axial location comprises at least some fuel ejection orifices configured for fuel-lean injection.

33. The apparatus of claim 29, wherein a shape of the fuel ejection orifices is selected from the group consisting of circular shape, elongated shape, oval shape and a combination of two or more of circular, elongated and oval shapes.
